(19) United States
(12) Patent Application Publication
(10) Pub. No.: US 2019/0188762 A1
(43) Pub. Date: Jun. 20, 2019

(54) INFORMATION PROCESSING APPARATUS AND INFORMATION PROCESSING METHOD

(71) Applicant: Bank Invoice Corporation, Tokyo (JP)

(72) Inventor: Taro Teshima, Tokyo (JP)

(21) Appl. No.: 16/188,302

(22) Filed: Nov. 13, 2018

Related U.S. Application Data
(63) Continuation of application No. PCT/JP2017/017396, filed on May 8, 2017.

(30) Foreign Application Priority Data
May 13, 2016 (JP) 2016-097094

(51) Int. Cl. G06Q 30/04; G06Q 20/14

(52) U.S. Cl. CPC G06Q 30/04; G06Q 20/14

(57) ABSTRACT

In an information processing apparatus, an invoice data storage unit stores therein invoice data in which at least one payment destination is previously set, and a data processing unit obtains a designated payment destination for each invoice data, and adds up invoice amounts indicated in the invoice data, for each payment destination.

### CROSS-REFERENCE TO RELATED APPLICATION

This application is a continuation application of International Application PCT/JP2017/017396 filed on May 8, 2017, designating the U.S. and claiming priority from Japanese Patent Application No. 2016-097094 filed on May 13, 2016. The entire contents of both foregoing applications are incorporated herein by reference.

### FIELD

The embodiment discussed herein relates to an information processing apparatus and an information processing method.

### BACKGROUND

There is known a technique for achieving unified management for viewing of business documents (for example, invoices and others) of an entire company or an entire corporate group and information thereof.

For example, there is known an information processing apparatus that has a first storage unit that stores therein user information associating user identification information identifying a user and at least one piece of unique information with each user, a generation unit that generates a code for each user from the unique information and user identification information stored in the first storage unit, under prescribed rules, a second storage unit that stores therein business document information including the user identification information of a first user that is included in the user information stored in the first storage unit, and a processing unit that determines, when receiving a request for access to business document information from a second user whose user information is stored in the first storage unit, whether the first code of the first user matches the second code of the second user, and when the first code matches the second code, gives the second user an access authority to access the business document information created by the first user and stored in the second storage unit.

Please see, for example, International Publication Pamphlet No. WO 2015/049948.

For example, there is a case where received invoice information includes a plurality of payment destination accounts.

An accounting personnel who has issued an invoice confirms payment after a bill-to party makes the payment. Conversely, the accounting personnel does not know which account is used for the payment until the bill-to party actually makes the payment.

Therefore, it would be convenient if the accounting personnel is able to get information in advance about the payment destination.

### SUMMARY

To achieve the above object, there is provided an information processing apparatus. The information processing apparatus includes: a memory configured to store therein aggregation target data in which at least one payment destination is previously set; and a processor configured to perform a process including obtaining a designated payment destination for each of the aggregation target data, and adding up invoice amounts indicated in the aggregation target data, for each payment destination, wherein each of the aggregation target data is given a status indicating whether a payment destination has been designated or not, and wherein the process further includes adding up invoice amounts indicated in the aggregation target data given a status indicating that no payment destination has been designated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an invoice management system according to one embodiment.

FIG. 2 is a view for explaining an example of a screen that is displayed on a terminal device after a login.

FIG. 3 illustrates a hardware configuration of an invoice management apparatus according to the embodiment.

FIG. 4 is a block diagram illustrating functions of the invoice management apparatus according to the embodiment.

FIG. 5 is a view for explaining an example of invoice data that is stored in an invoice data storage unit.

FIG. 6 is a view for explaining an example of virtual account data that is stored in a payment destination data storage unit.

FIG. 7 is views for explaining information that is displayed in a summary display area.

FIGS. 8A and 8B are views for explaining information that is displayed in the summary display area.

FIG. 9 is a view for explaining how to process returned invoice data.

FIG. 10 is a view for explaining how to process invoice data for which payment has been received.

FIG. 11 is a view for explaining an example of a date range screen.

FIG. 12 is a view for explaining an example of a payment schedule status list screen.

FIG. 13 is a view for explaining an example of the payment schedule status list screen.

FIG. 14 is a view for explaining another example of the payment schedule status list screen.

FIG. 15 is a flowchart illustrating a payment schedule status list screen generation process.

FIG. 16 is a view for explaining a second application example.

### DESCRIPTION OF EMBODIMENT(S)

Hereinafter, an invoice management system according to one embodiment will be described in detail with reference to the accompanying drawings.

### Embodiment

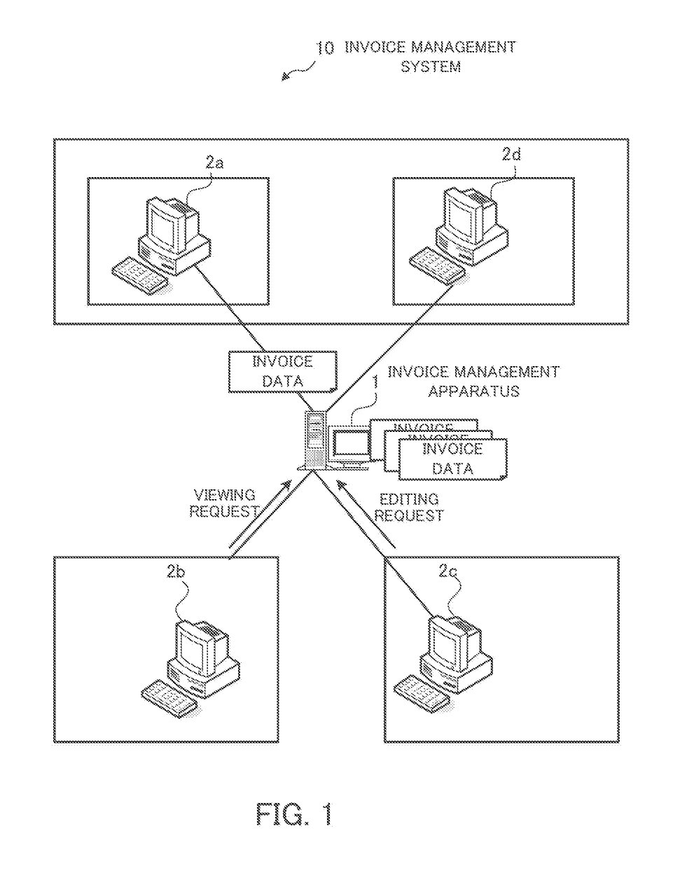

FIG. 1 illustrates an invoice management system according to one embodiment.

In the invoice management system 10 of the present embodiment, an invoice management apparatus 1 is connected to terminal devices 2a, 2b, 2c, and 2d over the Internet, a dedicated network, or another network.

The terminal devices 2a, 2b, and 2c are placed at accounting departments of different companies. For example, the terminal device 2a is placed at a company A, the terminal device 2b is placed at a company B, and the terminal device 2c is placed at a company C. In addition, the terminal device 2d is placed at the company A, but at a branch different from where the terminal device 2a is placed. In the following description, it is assumed that the terminal device 2a is placed at the Tokyo headquarters of the company A, whereas the terminal device 2d is placed at an Osaka branch of the company A.

Examples of the terminal devices 2a, 2b, 2c, and 2d include desktop personnel computers, laptop personnel computers, tablet terminals, and smartphones.

A web program is installed in the invoice management apparatus 1 and the terminal devices 2a, 2b, 2c, and 2d. The terminal devices 2a, 2b, 2c, and 2d communicate invoice data on invoices with the invoice management apparatus 1 through Web browsers. In this connection, this embodiment explains communication of invoice data by way of example, but invoice data is an example of aggregation target data. Other examples of aggregation target data include estimate forms, order forms, purchase order forms, prescriptions, and electronic medical records.

Hereinafter, it is assumed that the invoice management system 10 is used by the individual accounting persons of the companies A, B, and C.

Each accounting personnel of the companies A, B, and C performs user registration to the invoice management apparatus 1 using an assigned Email address or the like, in order to set up a connection to an invoice processing system provided by the invoice management apparatus 1.

After that, for example, the accounting personnel at the Tokyo headquarters of the company A operates the terminal device 2a to display a login screen provided by the invoice management apparatus 1 on a monitor connected to the terminal device 2a. The accounting personnel enters his/her mail address and password on the login screen, thereby logging in to the service provided by the invoice management apparatus 1. In this connection, the mail address is an example of identification information identifying the accounting personnel.

After the login, the accounting persons are able to operate their terminal devices 2a, 2b, 2c, and 2d to process invoice data, which is a digitized version of original invoices, via the invoice management apparatus 1. For example, the processing of invoice data include creation, sending, receipt, viewing, editing, and others.

For example, when the accounting personnel at the Tokyo headquarters of the company A issues an invoice to the company B, the accounting personnel at the Tokyo headquarters of the company A operates the terminal device 2a to create the invoice with the company B designated as a bill-to party, on a management screen that is displayed after a login. Then, the accounting personnel sends the invoice data with the mail address of the accounting personnel (recipient) of the company B designated as a destination of the created invoice. The sent invoice data is held by the invoice management apparatus 1.

That is, the invoice data is not communicated directly between the terminal devices 2a, 2b, 2c, and 2d. Rather, all invoice data created by the terminal devices 2a, 2b, 2c, and 2d and sent to bill-to parties is held by the invoice management apparatus 1. The invoice data is treated like shared data. The invoice management apparatus 1 gives viewing and editing authorities for the invoice data to the terminal devices 2a, 2b, 2c, and 2d according to necessity.

The above approach makes it possible to digitize and process original invoices electronically, which leads to saving labor for management and storage of paper- or PDF-based invoices.

As described above, invoice data is not communicated directly between the terminal devices 2a, 2b, 2c, and 2d. In the following description, however, in the case where invoice data addressed to the mail address of the accounting personnel of the company B is sent from the accounting personnel at the Tokyo headquarters of the company A, for example, an expression like “the accounting personnel receives the invoice data” may be used, as in the general communication of invoice data, for easy understanding.

In this connection, it is preferable that invoice data be communicated in an encrypted form between the invoice management apparatus 1 and each terminal device 2a, 2b, 2c, and 2d.

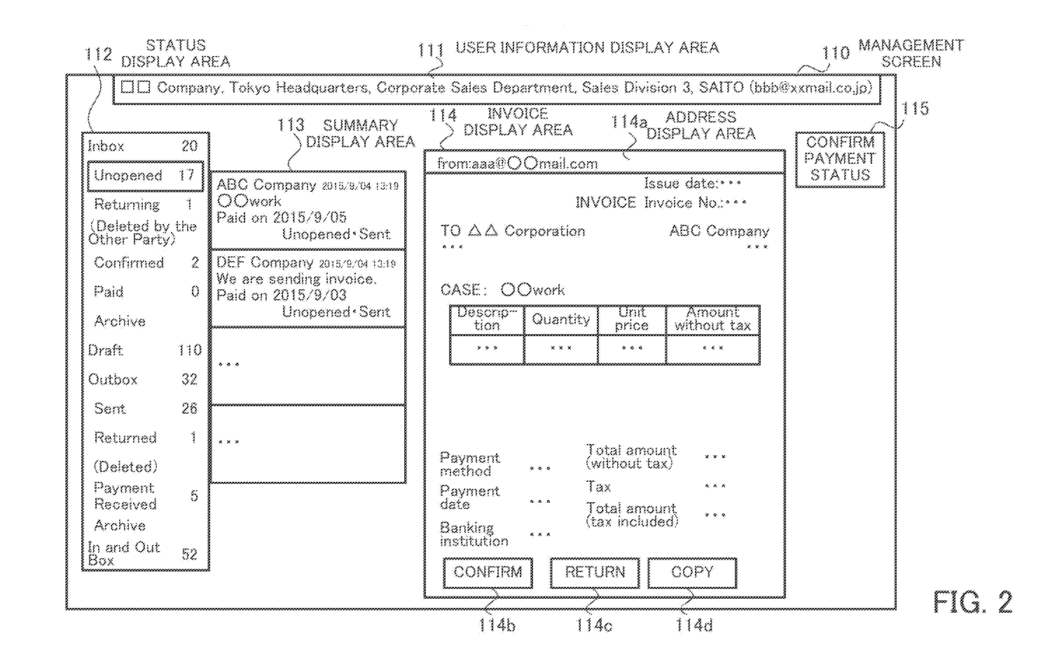

FIG. 2 is a view for explaining an example of a screen that is displayed on a terminal device after a login.

The management screen 110 illustrated in FIG. 2 is an example of a screen that is displayed on the terminal device 2a.

As illustrated in FIG. 2, an accounting personnel is able to create, issue, view, and edit invoice data, like he/she uses mail software.

By the way, in the above-described example, the accounting personnel at the Tokyo headquarters of the company A is not able to rewrite invoice data once he/she sends it. In addition, the accounting personnel of the company B is also not able to rewrite the invoice data. If the invoice data contains an error, another version of the invoice data needs to be issued. In this connection, the old version of the invoice data is held by the invoice management apparatus 1, without being deleted, such as to be viewable at any time. To this end, the invoice management apparatus 1 performs version management of the invoice data, so as to easily search for a new version of the invoice data on the basis of an old version of the invoice data or for an old version of the invoice data on the basis of a new version of the invoice data.

The management screen 110 will be described in detail later.

Now, the disclosed invoice management system will be described more concretely.

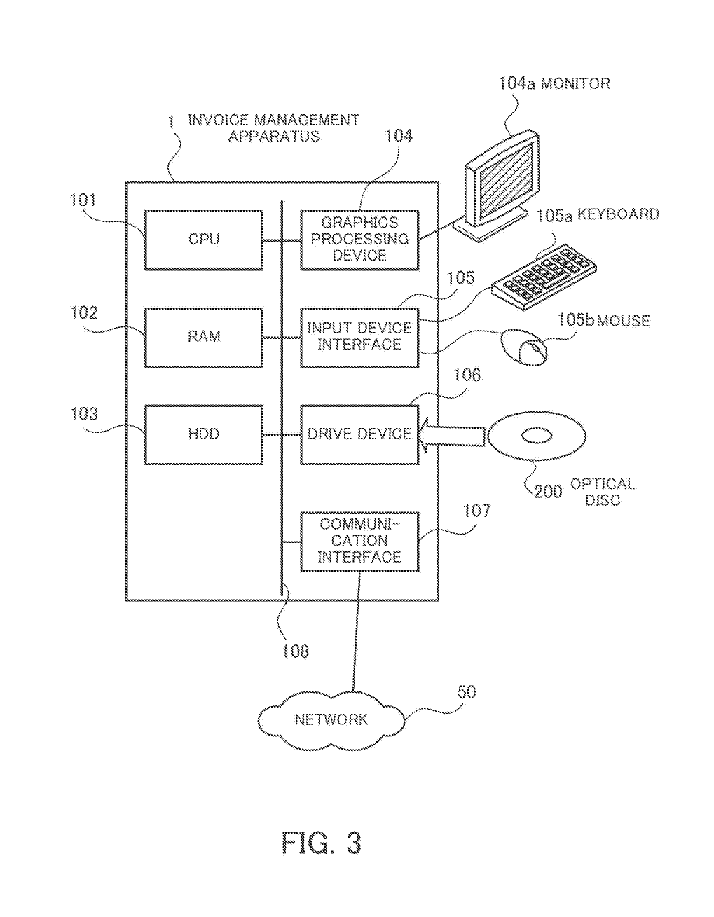

FIG. 3 illustrates a hardware configuration of the invoice management apparatus according to the present embodiment.

The invoice management apparatus 1 is entirely controlled by a CPU (central processing unit) 101. A RAM (random access memory) 102 and a plurality of peripheral devices are connected to the CPU 101 via a bus 108.

The RAM 102 is used as a main storage device of the invoice management apparatus 1. The RAM 102 temporarily stores therein at least part of OS (operating system) programs and application programs that are executed by the CPU 101. In addition, the RAM 102 stores therein various kinds of data to be used by the CPU 101 in processing.

Connected to the bus 108 are a HDD (hard disk drive) 103, a graphics processing device 104, an input device interface 105, a drive device 106, and a communication interface 107.

The HDD 103 magnetically writes and reads data on a built-in disk. The HDD 103 is used as an auxiliary storage device of the invoice management apparatus 1. The OS programs, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a display device using CRT (cathode ray tube) and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a USB (universal serial bus) memory. For example, in the case where the drive device 106 is an optical drive device, data recorded on an optical disc 200 may be read with laser light or the like. Examples of the optical disc 200 include Blu-ray (registered trademark), DVD (digital versatile disc), DVD-RAM, CD-ROM (compact disc read only memory), CD-R (recordable), and CD-RW (rewritable).

The communication interface 107 is connected to a network 50. The communication interface 107 communicates data with another computer or communication device over the network 50.

With the above hardware configuration, the processing functions of the present embodiment may be implemented. In this connection, FIG. 3 illustrates a hard configuration of the invoice management apparatus 1. The other computers including the terminal device 2a may be implemented with the same hardware configuration as the invoice management apparatus 1.

The invoice management apparatus 1 having the hardware configuration illustrated in FIG. 3 has the following functions.

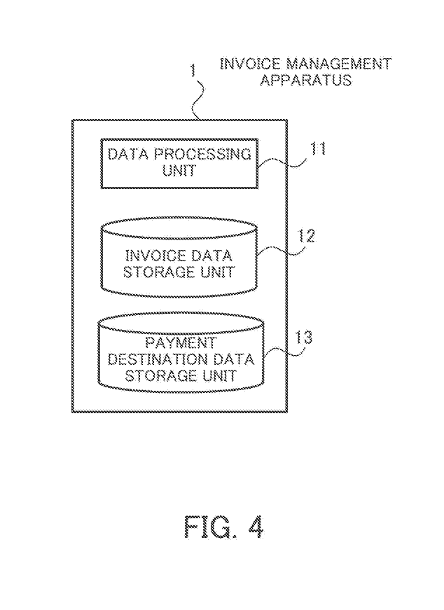

FIG. 4 is a block diagram illustrating functions of the invoice management apparatus according to the present embodiment.

The invoice management apparatus 1 has a data processing unit 11, an invoice data storage unit 12, and a payment destination data storage unit 13.

The data processing unit 11 displays the management screen 110 illustrated in FIG. 2 on a monitor connected to the terminal device 2a or the like in accordance with accounting personnel's operations. The data processing unit 11 performs appropriate processing according to operations made to invoice data on the management screen 110. For example, the data processing unit 11 stores invoice data received by the invoice management apparatus 1, in the invoice data storage unit 12.

The invoice data storage unit 12 stores therein invoice data received by the invoice management apparatus 1, by accounting personnel (more specifically, by mail address of accounting personnel). The invoice data received by the invoice management apparatus 1 includes invoice data sent from accounting persons of billing parties to accounting persons of bill-to parties and invoice data drafted by the accounting persons (issuers) of the billing parties.

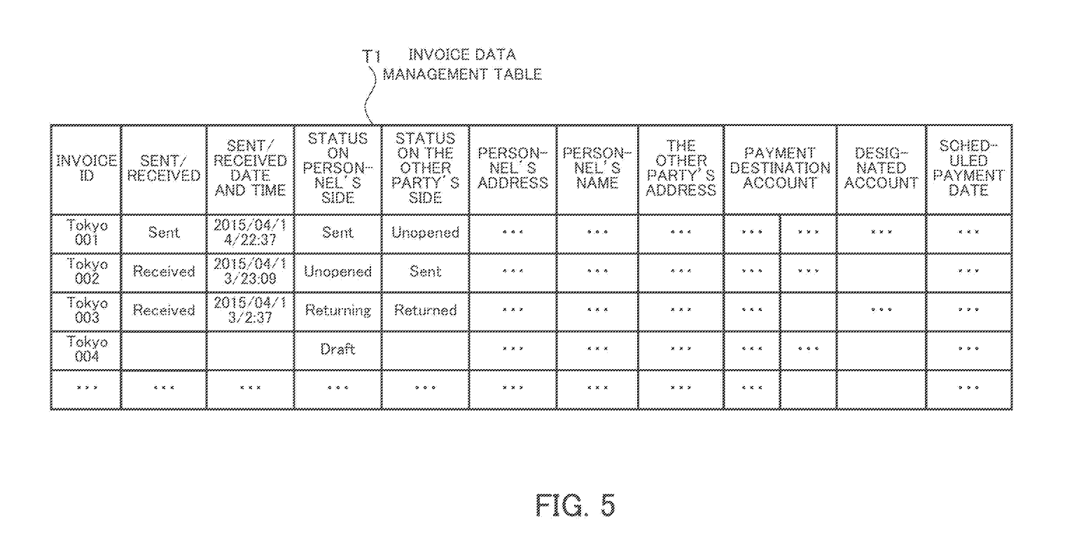

FIG. 5 is a view for explaining an example of invoice data stored in the invoice data storage unit.

In the present embodiment, data is stored in tabular form.

The invoice data management table T1 has the following columns: Invoice ID, Sent/Received, Sent/Received Date and Time, Status on Personnel's Side, Status on the Other Party's Side, Personnel's Address, Personnel's Name, The Other Party's Address, Payment Destination Account, Designated Account, and Scheduled Payment Date. Information pieces arranged in horizontal direction are associated with each other.

The Invoice ID column contains an ID unique to invoice data for use in management of invoice data. When the invoice management apparatus 1 receives invoice data, the data processing unit 11 gives an invoice ID to the invoice data.

In this embodiment, “Tokyo” plus number is given to invoice data issued by the Tokyo headquarters, whereas “Osaka” plus number is given to invoice data issued by the Osaka branch.

The Sent/Received column indicates whether the invoice data is data that has been received or sent, in view of the accounting personnel. More specifically, “Received” indicates that the invoice data is received data, whereas “Sent” indicates the invoice data is sent data.

The Sent/Received Date and Time column contains the latest date and time among dates and times when the invoice data was sent and received.

The Status on Personnel's Side column contains the status (processing progress) of the invoice data in view of the accounting personnel.

The Status on the Other Party's Side column contains the status of the invoice data in view of the accounting personnel of the other party that communicates the invoice data.

The statuses to be set in the Status on Personnel's Side and Status on the Other Party's Side columns include the following: “Unopened,” “Returning,” “Deleted by the Other Party,” “Confirmed,” “Paid,” “Archive,” “Sent,” “Returned,” “Deleted,” and “Payment Received.” These statuses will be described in detail later.

The Personnel's Address column contains the mail address of the accounting personnel.

The Personnel's Name column contains the department to which the accounting personal belongs and the name of the accounting personnel.

The Other Party's Address column contains the mail address of the accounting personnel of the other party that communicates the invoice data.

In addition to the above-described information, the invoice data management table contains information described in typical invoices, including the company name of the accounting personnel, the company name of the accounting personnel of the other party that communicates the invoice data, the postal codes and addresses of both companies, departments, and others.

The Payment Destination Account column contains at least one of the bank name, branch name, and account number of a payment destination account set by the accounting personnel at the time of creating the invoice data.

The Designated Account column indicates an account to which payment is to be made, selected from payment destination accounts by the accounting personnel of the other party.

The Scheduled Payment Date column contains a scheduled date indicating when an invoice amount is credited to an account (for example, a scheduled date designated by the accounting personnel).

In this embodiment, the payment destination account numbers are managed using virtual account numbers.

In this connection, virtual account numbers are used for the management, but the virtual accounts may not be used.

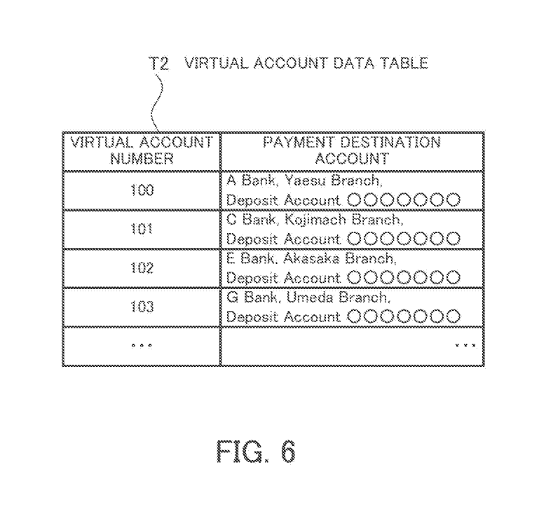

FIG. 6 is a view for explaining an example of virtual account data that is stored in the payment destination data storage unit.

The virtual account data table T2 contains therein a virtual account number and the account number of an actual payment destination account in association with each other.

In this connection, this virtual account data table T2 contains virtual account numbers for not only accounts managed by the Tokyo headquarters of the company A but also account numbers managed by the other branches of the company A.

In the following description, it is assumed that the account number of the Umeda branch of G bank registered in the virtual account data table T2 is managed by the Osaka branch of the company A.

The following describes the management screen 110 illustrated in FIG. 2.

(Management Screen)

The data processing unit 11 displays the management screen 110 illustrated in FIG. 2 on the terminal device 2a or the like in accordance with accounting personnel's operations.

The management screen 110 has a user information display area 111, a status display area 112, a summary display area 113, an invoice display area 114, and a Confirm Payment Status button 115.

The user information display area 111 displays information (user information) on an accounting personnel that has logged in to the invoice management system. Referring to FIG. 2, the user information display area 111 displays the names of a company and department to which the accounting personnel belongs, and the surname and mail address of the accounting personnel.

The status display area 112 displays the number of pieces of invoice data that is handled by the accounting personnel that has logged in to the invoice management system, for each status.

Roughly, the status display area 112 includes the following folders: Inbox, Draft, Outbox, and In and Out Box.

The data processing unit 11 places invoice data with the mail address of the accounting personnel designated as a recipient, into the Inbox folder.

When the accounting personnel selects the Inbox folder, the data processing unit 11 refers to the invoice data management table T1. Then, the data processing unit 11 displays, in the summary display area 113, the summary of invoice data that has “Received” in the Sent/Received column, among the invoice data that has “bbb@xxmail.co.jp” in the Personnel's Address column.

As illustrated in FIG. 2, invoice data placed in the Inbox folder has the following statuses: “Unopened,” “Returning,” “Deleted by the Other Party,” “Confirmed,” “Paid,” and “Archive.”

The “Unopened” status is given by the data processing unit 11 to invoice data that has not been confirmed by the accounting personnel among the invoice data placed in the Inbox folder.

The “Returning” status is given by the data processing unit 11 to invoice data that has been returned from the accounting personnel to the accounting personnel of the billing party among the invoice data placed in the Inbox folder.

The “Deleted by the Other Party” status is given by the data processing unit 11 to invoice data that has been received, returned by the accounting personnel to the accounting personnel of the billing party, and then deleted by the accounting personnel of the billing party, among the invoice data placed in the Inbox folder.

The “Confirmed” status is given by the data processing unit 11 to invoice data which the accounting personnel has viewed and for which the accounting personnel has selected a Confirm button (will be described later), among the invoice data placed in the Inbox folder.

The “Paid” status is given by the data processing unit 11 to invoice data for which the accounting personnel has made payment and then selected a Paid button (to be described later), among the invoice data placed in the Inbox folder.

The accounting personnel aggregates the invoice data in the Paid status to confirm the details of the payment.

The “Archive” status is given by the data processing unit 11 to invoice data which the accounting personnel has saved in an archive at certain timing, among the invoice data in the “Paid” status.

A number displayed in association with each status in the status display area 112 indicates the number of pieces of invoice data in the status.

For example, the Unopened status in the status display area 112 indicates the number of pieces of invoice data that have not been confirmed by the accounting personnel among received invoice data.

In this connection, the Archive status in the status display area 112 does not specifically indicate any number.

When the accounting personnel would like to view the content of invoice data in a desired one of the “Unopened,” “Retuning,” “Deleted by the Other Party,” “Confirmed,” “Paid,” and “Archive” statuses, he/she just selects the desired status in the status display area 112.

For example, when the accounting personnel selects the Unopened status, the data processing unit 11 refers to the invoice data management table T1. The data processing unit 11 then displays the summary of the invoice data having Unopened in the Status on Personnel's Side column among the invoice data having “bbb@xxmail.co.jp” in the Personnel's Address column, in the summary display area 113.

The data processing unit 11 places invoice data that has been created and saved by the accounting personnel but has not been sent to the accounting personnel of the recipient, in the Draft status.

The data processing unit 11 places invoice data that has been sent by the accounting personnel, into the Outbox folder.

When the accounting personnel selects the Outbox folder, the data processing unit 11 refers to the invoice data management table T1. The data processing unit 11 then displays the summary of the invoice data having “Sent” in the Sent/Received column among the invoice data having “bbb@xxmail.co.jp” in the Personnel's Address column, in the summary display area 113.

As illustrated in FIG. 2, invoice data placed in the Outbox folder has the following statuses: “Sent,” “Returned,” “Deleted,” “Payment Received,” and “Archive.”

The “Sent” status is given by the data processing unit 11 to invoice data for which the accounting personnel of the bill-to party has not made payment, among the invoice data placed in the Outbox folder.

The “Returned” status is given by the data processing unit 11 to invoice data that has been returned from the accounting personnel of the bill-to party, among the invoice data placed in the Outbox folder. The accounting personnel is able to process the invoice data returned from the bill-to party.

The “Deleted” status is given by the data processing unit 11 to invoice data that has been deleted by the accounting personnel of the billing party, among the invoice data returned from the accounting personnel of the bill-to party.

The “Payment Received” status is given by the data processing unit 11 to invoice data for which the accounting personnel of the billing party has confirmed payment and selected a Payment Received button (will be described later), among the invoice data placed in the Outbox folder.

The “Archive” status is given by the data processing unit 11 to invoice data which the accounting personnel has saved in the Archive at certain timing, among the invoice data in the “Payment Received” status.

The Archive status in the status display area 112 does not specifically indicate any number.

What is needed to view the content of invoice data in a desired one of the “Sent,” “Returned,” “Deleted,” “Payment Received,” and “Archive” statuses is just to select the desired status.

The summary display area 113 displays the summary of invoice data corresponding to a status selected by the accounting personnel in the status display area 112, as described earlier. The summary of received invoice data may include the company name of a billing party, a case name, a payment date and time, a status on the sender side, and a status on the recipient side.

The same statuses are displayed on the management screens of both the accounting personnel who has sent invoice data and the accounting personnel who has received the invoice data.

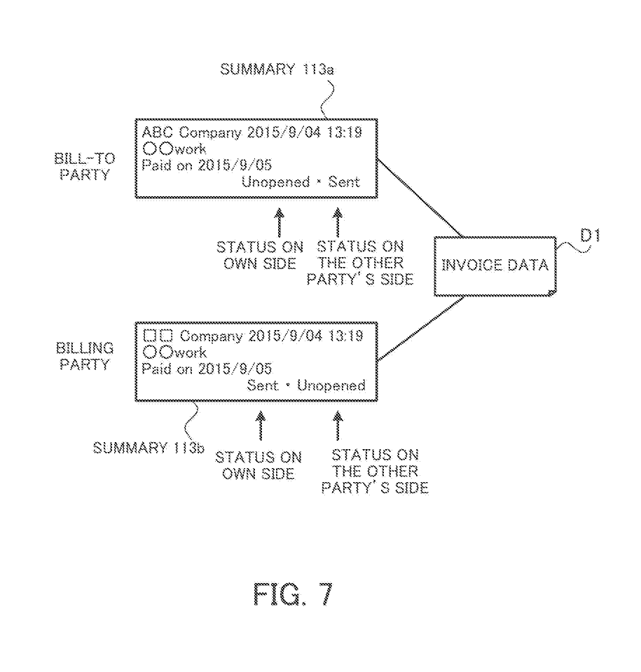

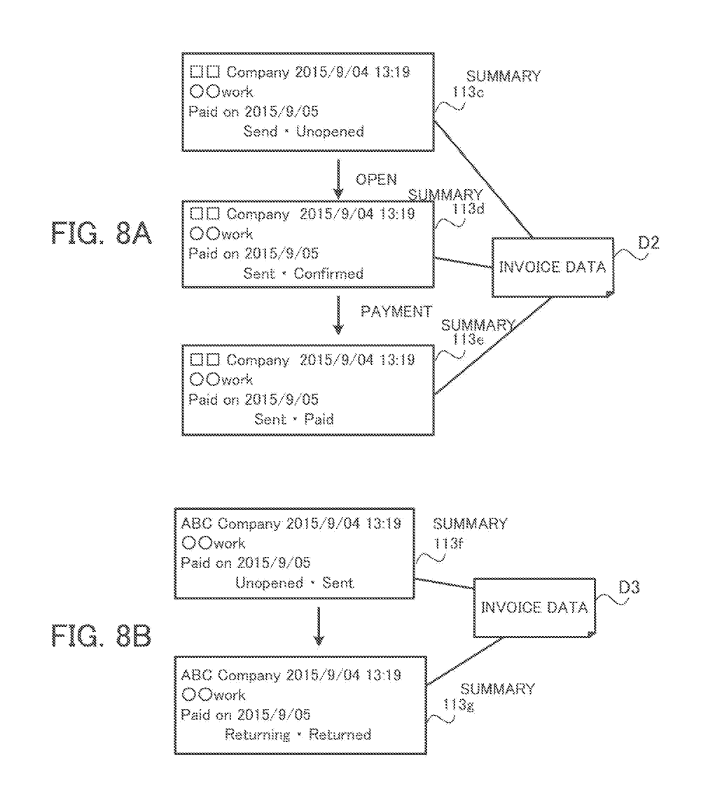

FIGS. 7 and 8 are views for explaining information that is displayed in the summary display area.

FIG. 7 illustrates a summary 113a of invoice data that is displayed in the summary display area 113 of the management screen 110 viewed by the accounting personnel of the bill-to party, and a summary 113b that is displayed in the summary display area 113 of the management screen 110 viewed by the accounting personnel of the billing party.

More specifically, invoice data D1 with a billing party of ABC company and a case name of OO work, as illustrated in FIG. 7, is placed in the “Sent” status in the status display area on the management screen of the terminal device operated by the accounting personnel of the billing party. When the accounting personnel of the billing party selects the “Sent” status in the status display area, the following information is displayed with respect to the invoice data D1 in the summary display area 113: a bill-to party is □□ company, a case name is OO work, a status on the accounting personnel's side of the billing party is “Sent,” and a status on the accounting personnel's side of the bill-to party is “Unopened.”

By confirming status transitions, the accounting personnel of the billing party is able to easily confirm the progress of processing made by the accounting personnel of the bill-to party. That is to say, the accounting persons of both parties are able to confirm the current status of each invoice data in real-time.

All summaries 113c, 113d, and 113e illustrated in FIG. 8A are of invoice data D2.

When the accounting personnel of the bill-to party has viewed the invoice data D2 and selected a Confirm button (will be described later), the data processing unit 11 changes information displayed in the summary display area 113 from the summary 113c to the summary 113d on the management screen 110 of the terminal device operated by the accounting personnel of the billing party.

After that, when the accounting personnel of the bill-to party has made payment for the invoice data D2 and selected a Paid button (will be described later), the data processing unit 11 changes information displayed in the summary display area 113 from the summary 113d to the summary 113e on the management screen 110 of the terminal device operated by the accounting personnel of the billing party.

As another example, both summaries 113f and 113g illustrated in FIG. 8B are of invoice data D3.

When the accounting personnel of the bill-to party has viewed the invoice data D3 and selected a Return button (will be described later), the data processing unit 11 changes information displayed in the summary display area 113 from the summary 113f to the summary 113g on the management screen of the terminal device operated by the accounting personnel of the bill-to party.

Refer now back to FIG. 2.

When the accounting personnel has selected the summary of invoice data being displayed in the summary display area 113, the data processing unit 11 displays the content of the invoice data in the invoice display area 114. The content of the invoice to be displayed in the invoice display area 114 is the same as that of existing (paper-based or PDF-based) invoices, except that an address display area 114a and various buttons, which will be described later, are displayed.

Information including at least one payment destination (bank name plus branch name plus account number) is displayed in the invoice display area 114. In the case where a plurality of payment destinations are displayed, the accounting personnel of the bill-to party designates one payment destination before performing a payment process for the invoice data. For this designation of the payment destination, a method of displaying a check box in association with each payment destination previously set by the accounting personnel of the billing party in the invoice display area 114 to allow the accounting personnel of the bill-to party to designate one of the payment destinations, a method of displaying a pull-down list to allow the accounting personnel of the bill-to party to select a desired payment destination, and other methods are considered. The former method is one example of a method of setting payment destinations by the accounting personnel of the billing party, whereas the latter method is one example of a method of designating a payment destination by the accounting personnel of the bill-to party.

The data processing unit 11 registers the payment destination (designated information) designated by the accounting personnel of the bill-to party in the Designated Account column of the invoice data management table T1.

When the accounting personnel views invoice data placed in the Inbox folder, the data processing unit 11 displays the mail address of a sender accounting personnel (from) in the address display area 114a.

When the accounting personnel views invoice data placed in the Draft status or Outbox folder, the data processing unit 11 displays the mail address of a recipient accounting personnel (to).

In this connection, the data processing unit 11 may display the invoice ID of the invoice data in the invoice display area 114.

The accounting personnel is able to process an invoice being displayed in the invoice display area 114 on the management screen 110.

More specifically, buttons for processing the invoice are displayed in the invoice display area 114 according to the status of the invoice data.

FIG. 2 illustrates buttons that are displayed when invoice data in the Unopened status is selected.

The invoice display area 114 includes a Confirm button 114b, a Return button 114c, and a Copy button 114d.

When the accounting personnel selects the Confirm button 114b, the data processing unit 11 refers to the invoice data management table T1. The data processing unit 11 then changes the Status on Personnel's Side column to “Confirmed” with respect to the invoice data being displayed in the invoice display area 114. In addition, the data processing unit 11 decreases the number for the “Unopened” status by one and increases the number for the “Confirmed” status by one in the status display area 112.

When the accounting personnel selects the Return button 114c, the data processing unit 11 refers to the invoice data management table T1. The data processing unit 11 then changes the Status on Personnel's Side column to “Returning” with respect to the invoice data being displayed in the invoice display area 114, and then changes the Status on the Other Party's Side column to “Returned”. In addition, the data processing unit 11 decreases the number for the “Unopened” status by one and increases the number for the “Returning” status by one in the status display area 112.

On the management screen of the accounting personnel who has received the returned invoice data, the number for the Returned status in the status display area is increased by one.

When the accounting personnel selects the Copy button 114d, the data processing unit 11 creates new invoice data by replacing the company name and address between the billing party and the bill-to party in the invoice data. Then, the data processing unit 11 registers information on the created invoice data in the invoice data management table T1. At this time, with respect to the invoice data, “Draft” is set in the Status on Personnel's Side column and a blank is set in the Status on the Other Party's Side column.

(Returns Process)

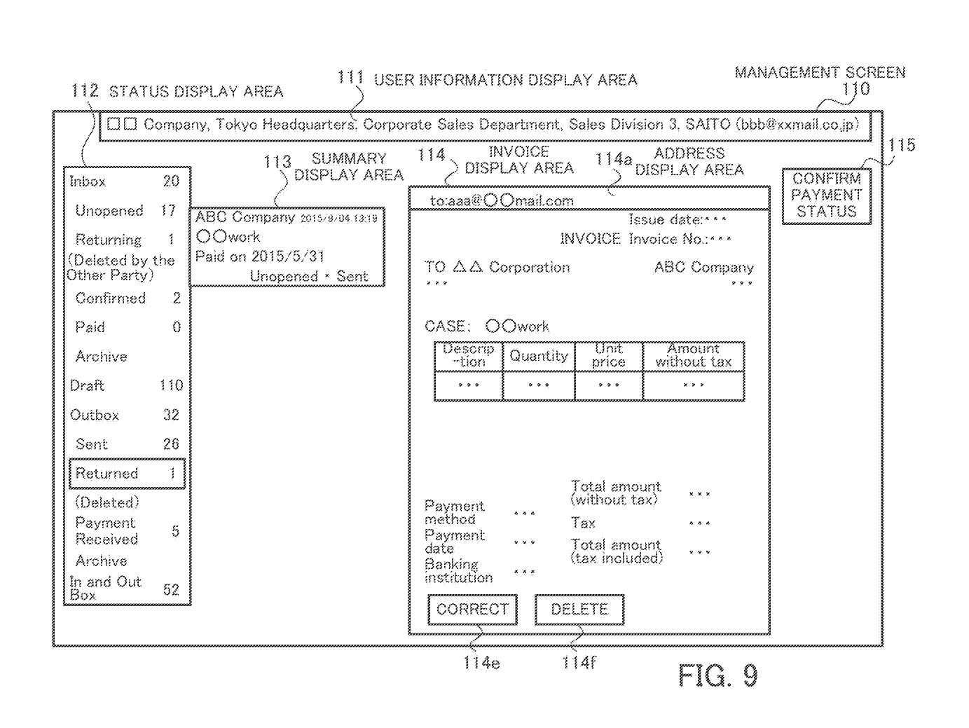

FIG. 9 is a view for explaining how to process returned invoice data.

When the accounting personnel selects the Returned status in the status display area 112 and then selects the summary of an invoice being displayed in the summary display area 113, the data processing unit 11 displays invoice data corresponding to the summary of the selected invoice in the invoice display area 114. In this case, the mail address of the accounting personnel of the bill-to party is displayed in the address display area 114a.

The invoice display area 114 includes a Correct button 114e and a Delete button 114f.

When the accounting personnel selects the Correct button 114e, the data processing unit 11 changes the status of the invoice data being displayed in the invoice display area 114 to “Deleted”. In addition, the data processing unit 11 decreases the number for the “Returned” status by one in the status display area 112. Then, this information is added as a history.

When the accounting personnel selects the Delete button 114f, the data processing unit 11 changes the status of the invoice data being displayed in the invoice display area 114 to “Deleted”. Thereby, the numbers for the “Outbox” folder and “Returned” status are each decreased by one in the status display area 112.

In this connection, the accounting personnel of the billing party and the accounting personnel of the bill-to party are able to view invoice data even after the invoice data is deleted.

More specifically, the accounting personnel of the billing party is able to view deleted invoice data by selecting the “Deleted” status in the status display area 112. On the other hand, the accounting personnel of the bill-to party is able to view deleted invoice data by selecting the “Deleted by the Other Party” status in the status display area 112.

(Payment Receipt Process)

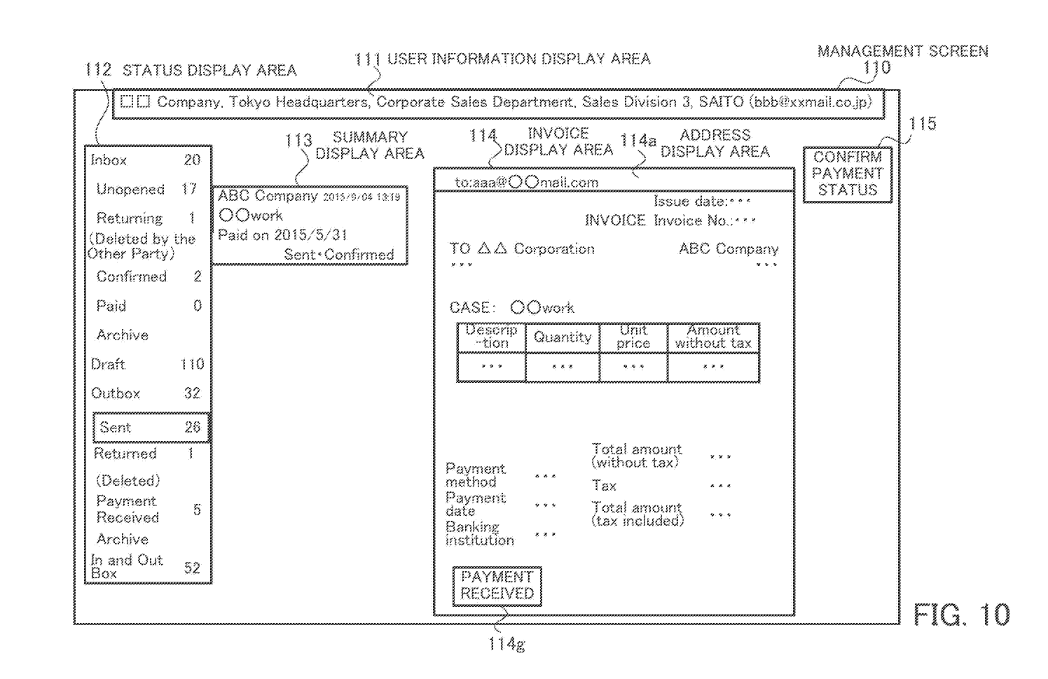

FIG. 10 is a view for explaining how to process invoice data for which payment has been received.

After the accounting personnel has confirmed payment for an invoice, the accounting personnel selects the Sent status in the status display area 112 to display the summary of invoices in the Sent status in the summary display area 113.

When the accounting personnel selects the summary of the invoice for which he/she has confirmed the payment, from the summary of the invoices displayed in the summary display area 113, the data processing unit 11 displays invoice data corresponding to the summary of the selected invoice in the invoice display area 114. In this case, the mail address of the accounting personnel of the bill-to party is displayed in the address display area 114a.

A Payment Received button 114g is provided in the invoice display area 114.

When the accounting personnel selects the Payment Received button 114g, the data processing unit 114 changes the status of the invoice data being displayed in the invoice display area 114 to “Payment Received”. In addition, the data processing unit 11 decreases the number for the “Sent” status by one and increases the number for the “Payment Received” status by one in the status display area 112. Then, this information is added as a history.

Among all invoice data placed in the Inbox and Outbox folders, data other than deleted invoice data, invoice data saved in the archive, and invoice data in the Draft status is placed in the In and Out Box folder.

The following describes a process that is performed when the accounting personnel selects a Confirm Payment Status button 115.

When the accounting personnel selects the Confirm Payment Status button 115, the data processing unit 11 displays a date range screen on the monitor connected to the terminal device 2a.

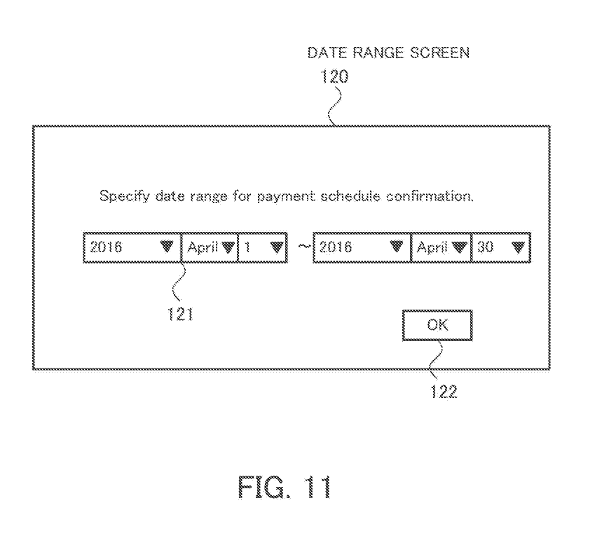

FIG. 11 is a view illustrating an example of a date range screen.

The date range screen 120 has a date range specification area 121 and an OK button 122.

When the accounting personnel specifies a range of dates and selects the OK button 122, the data processing unit 11 creates a payment schedule status list on the basis of payment destination information set in invoice data. Then, the data processing unit 11 displays a payment schedule status list screen on the terminal device.

In this connection, a desired range of dates may be set. For example, the accounting personnel is able to desirably set a date range, like a monthly date range, a yearly date range, and another, for example.

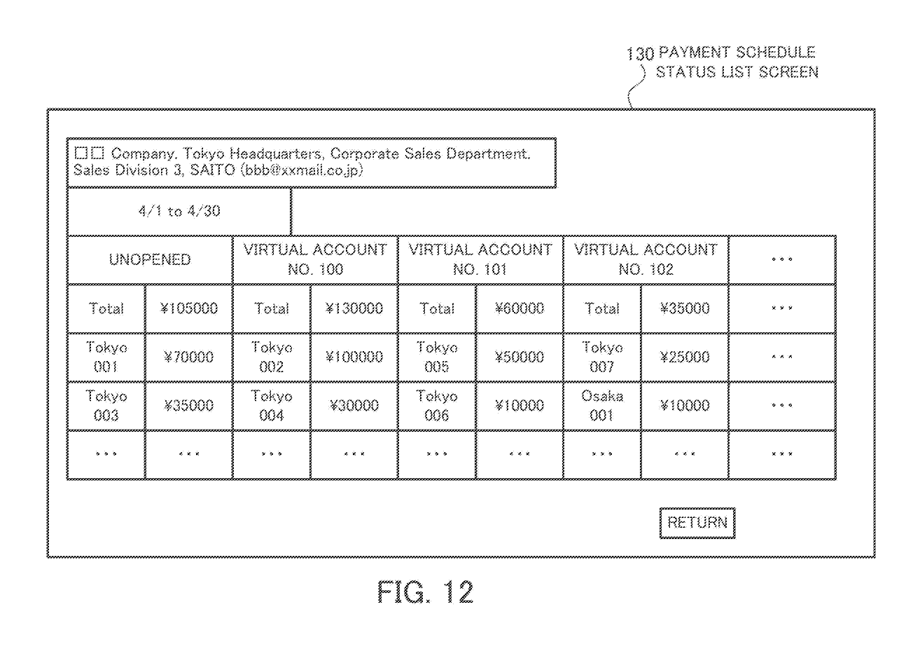

FIG. 12 is a view illustrating an example of the payment schedule status list screen.

The payment schedule status list screen 130 displays invoice amounts in association with the corresponding invoice IDs, with respect to each of the plurality of payment destination accounts set in invoice data. In addition, the payment schedule status list screen 130 displays the total amount that is scheduled to be credited to each of the accounts.

The payment schedule status list screen 130 displays, by virtual account, a schedule of amounts to be credited to the account numbers managed by the Tokyo headquarters of the company A between April 1 to April 30, among invoices issued to companies by the accounting personnel at the Tokyo headquarters of the company A.

Thereby, the accounting personnel at the Tokyo headquarters of the company A is able to easily confirm how much is scheduled to be credited to each account, with respect to the invoices issued by him/her.

In this connection, this embodiment describes the case where the accounting personnel at the Tokyo headquarters of the company A displays a payment schedule with respect to the invoices issued by him/her, for easy understanding. However, in the case where there are a plurality of accounting persons at the Tokyo headquarters, their boss may be allowed to view a payment schedule with respect to all account numbers managed by the Tokyo headquarters, for example.

The Unopened column indicates the invoice IDs and invoice amounts of invoice data classified under the “Unopened” status (i.e., an example of invoice data classified under a status indicating that a payment destination has not been designated).

In this connection, there is a possibility that the accounting personnel of the bill-to party has overlooked invoice data in the “Unopened” status. In case this happens, for example, the accounting personnel at the Tokyo headquarters of the company A is able to confirm the bill-to party indicated in the invoice data and send a reminder regarding the invoice data to the bill-to party.

In addition, by viewing the payment schedule status list screen 130, the accounting personnel at the Tokyo headquarters of the company A is able to confirm that the amount on the invoice data with invoice ID “Osaka 001” created by the accounting personnel at the Osaka branch of the company A is to be transferred to the “virtual account number 102”.

Thereby, the accounting personnel at the Tokyo headquarters of the company A is able to easily confirm what an amount to be credited to an account is for.

In addition, for example, by selecting “Osaka 001” in the screen, the name and mail address of the accounting personnel that has created the invoice data with “Osaka 001” may be displayed or a chat window may be opened for direct communication with the accounting personnel at the Osaka branch of the company A who has created the invoice data with “Osaka 001”.

In this connection, although not illustrated, only a payment schedule regarding invoices issued by the Tokyo headquarters may be sorted and displayed. Also, only a payment schedule regarding invoices issued by another branch, such as the Osaka branch, may be sorted and displayed.

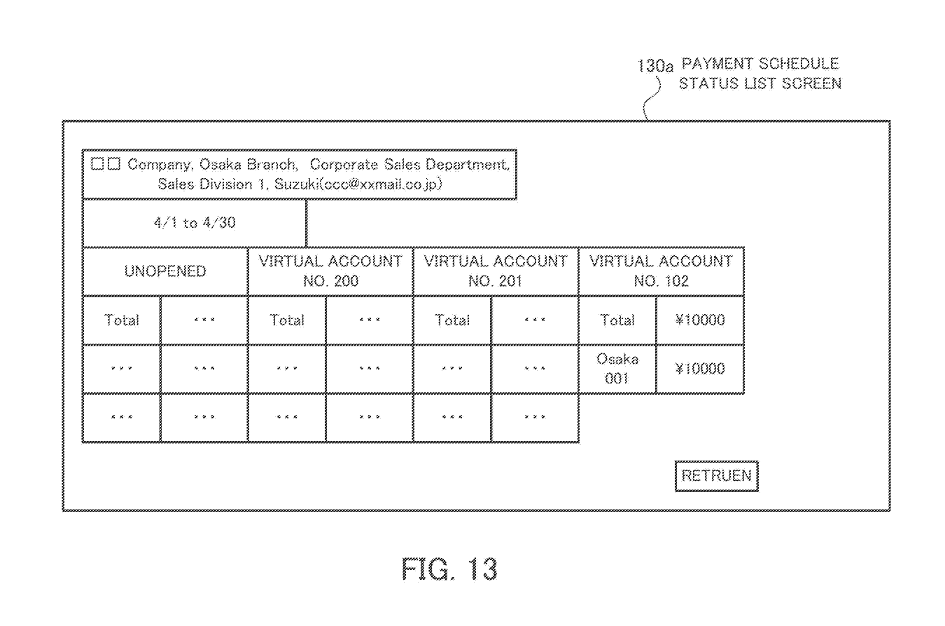

FIG. 13 is a view illustrating an example of the payment schedule status list screen.

The payment schedule status list screen 130a is displayed on a monitor connected to the terminal device 2d operated by the accounting personnel at the Osaka branch of the company A.

The payment schedule status list screen 130a displays, by virtual account, a schedule of amounts to be credited to account numbers managed by the Osaka branch of the company A between April 1 and April 30, among invoices issued to companies by the accounting personnel at the Osaka branch of the company A.

It is now assumed that a payment destination, “virtual account number 200” and “virtual account number 201” are set in the invoice data with invoice ID “Osaka 001” created by the accounting personnel at the Osaka branch. However, the bill-to party desires the money transfer to another payment destination, e.g., to “virtual account number 102”.

Even in this case, the accounting personnel at the Osaka branch of the company A is able to confirm that the payment for the invoice data with invoice ID “Osaka 001” created by the accounting personnel at the Osaka branch of the company A is to be made to the account of “virtual account number 102”, with reference to the payment schedule status list screen 130a.

By the way, FIG. 12 illustrates a total amount for each virtual account number. However, alternatively, virtual account numbers may be arranged and displayed in association with the respective invoice data.

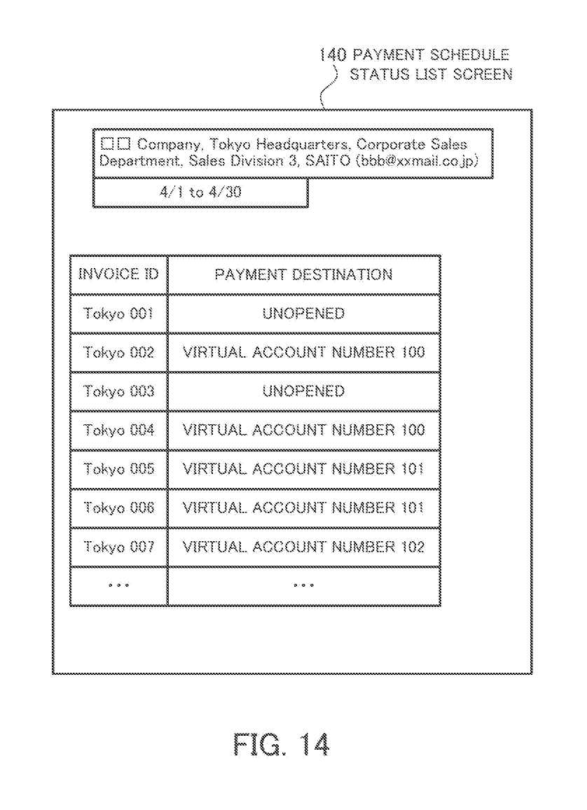

FIG. 14 illustrates another example of the payment schedule status list screen.

The payment schedule status list screen 140 illustrated in FIG. 14 displays virtual account numbers arranged in association with respective invoice data with respect to invoices issued between April 1 and April 30, among invoices issued to companies by the accounting personnel at the Tokyo headquarters of the company A.

By viewing this screen, it is possible to easily confirm to which account a payment is to be made, with respect to each invoice data. Although not illustrated, the accounting personnel at the Osaka branch of the company A is also able to confirm with reference to the payment schedule status list screen that payment for the invoice data with invoice ID “Osaka 001” is to be made to the virtual account number 102.

The following is a flowchart illustrating how the data processing unit 11 generates the payment schedule status list screen 130 (payment schedule status list screen generation process).

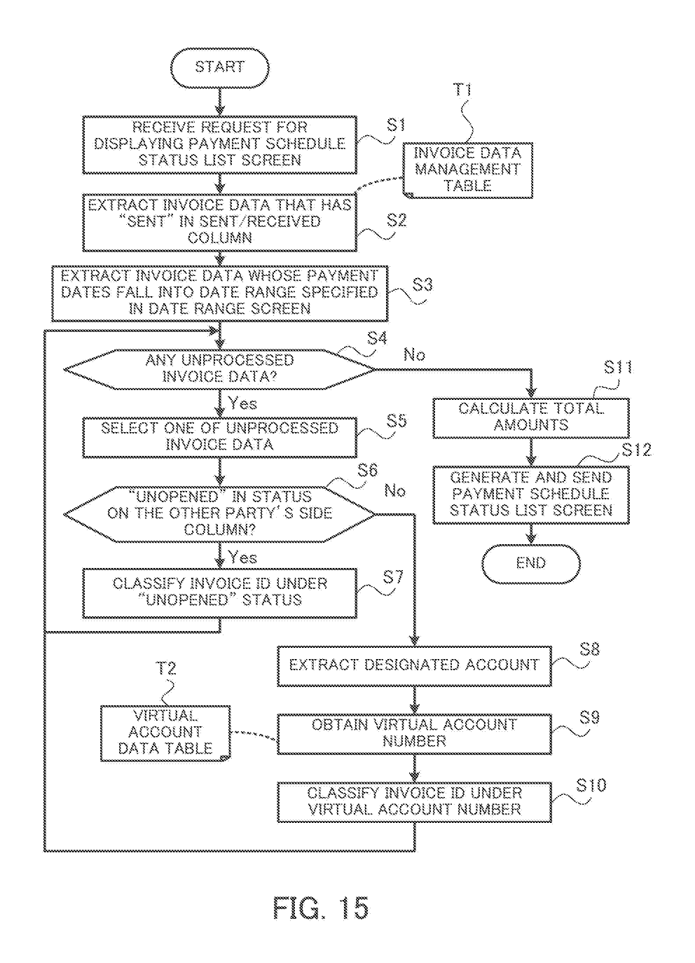

FIG. 15 is a flowchart for explaining the payment schedule status list screen generation process.

(Step S1) When the data processing unit 11 receives a request for displaying the payment schedule status list screen 130, the process proceeds to step S2.

The data processing unit 11 refers to the invoice data management table T1 and extracts invoice data that has the mail address of the accounting personnel who has logged in to the system in the Personnel's Address column and has “Sent” in the Sent/Received column (that is, invoice data sent by the accounting personnel). Then, the process proceeds to step S3.

(Step S3) The data processing unit 11 refers to the scheduled payment dates of the invoice data extracted at step S2, and extracts invoice data whose payment dates fall into a date range specified in the date range screen 120. Then, the process proceeds to step S4.

(Step S4) The data processing unit 11 determines whether the invoice data extracted at step S3 includes any unprocessed invoice data (i.e., any invoice data for which steps S5 to S10 have not been executed). If unprocessed invoice data exists (Yes at step S4), the process proceeds to step S5. If all the invoice data has been processed (No at step S4), the process proceeds to step S11.

(Step S5) The data processing unit 11 selects one of the unprocessed invoice data. Then, the process proceeds to step S6.

(Step S6) The data processing unit 11 determines with reference to the Status on the Other Party's Side column whether the invoice data selected at step S5 has the “Unopened” status. If the invoice data has the “Unopened” status in the Status on the Other Party's Side column (Yes at step S6), the process proceeds to step S7. If the invoice data has another status in the Status on the Other Party's Side column (No at step S6), the process proceeds to step S8.

(Step S7) The data processing unit 11 classifies the invoice ID of the invoice data selected at step S5 under the “Unopened” status. Then, the process proceeds back to step S4.

(Step S8) The data processing unit 11 refers to the invoice data selected at step S5, and then extracts a payment destination account registered in the Designated Account column. Then, the process proceeds to step S9.

(Step S9) The data processing unit 11 refers to the virtual account data table T2 and obtains a virtual account number corresponding to the payment destination account extracted at step S8. Then, the process proceeds to step S10.

(Step S10) The data processing unit 11 classifies the invoice ID of the invoice data selected at step S5 under the virtual account number obtained at step S9. Then, the process proceeds back to step S4.

(Step S11) The data processing unit 11 generates aggregated data that is a total amount of the invoice data with invoice IDs classified under the “Unopened” status. In addition, the data processing unit 11 generates aggregated data that is a total amount of the invoice data for each virtual account number. Then, the process proceeds to step S12.

(Step S12) The data processing unit 11 generates the payment schedule status list screen 130 on the basis of the total amounts obtained at step S11. The data processing unit 11 displays the generated payment schedule status list screen 130 on the monitor connected to the terminal device 2a.

FIG. 15 has been described.

As described above, in the invoice management system 10, the invoice management apparatus 1 is designed to generate the payment schedule status list screen 130. This enables the accounting personnel of the billing party to obtain information in advance about a payment destination account for each invoice data, both in the case where the accounting personnel of the billing party designates a payment destination and in the case where the accounting personnel of the bill-to party designates a payment destination.

As described earlier, invoice data is not communicated directly between the terminal devices 2a, 2b, 2c, and 2d. Rather, all invoice data created using the terminal devices 2a, 2b, 2c, and 2d and sent to bill-to parties is held by the invoice management apparatus 1 and is treated like shared data. Therefore, an accounting personnel of each bill-to party is able to obtain an original invoice by printing out the invoice data.

In addition, electronic signature processing, timestamp processing, and other processing are not needed, thereby making it possible to save labor for converting paper-based invoices to PDF files for tax inquiry.

The following describes application examples of a process that is performed upon receipt of payment.

### First Application Example

As described with reference to FIG. 10, in the above-described embodiment, the accounting personnel of the billing party confirms payment, and selects the Payment Received button 114g after confirming the receipt of the payment, so that the status is changed to “Payment Received”.

However, alternatively, when the accounting personnel of the bill-to party makes payment for invoice data, as illustrated in FIG. 8A, and then selects the Paid button, the data processing unit 11 may refer to the invoice data management table T1 and set the status of the invoice data to “Payment Received” in the Status on the Other Party's Side column.

By doing so, when the accounting personnel of the billing party views the management screen 110, the invoice data for which the payment has been made is automatically placed in the “Payment Received” status in the status display area 112.

In addition, the timing for changing the status to “Payment Received” is not limited thereto, and the status may be changed to “Payment Received” when a bank or a personnel at the recipient company confirms the receipt of the payment (i.e., when they performs the payment receipt process).

### Second Application Example

In the first application example, the accounting personnel of the bill-to party performs a payment process for invoice data and selects the Paid button.

However, the system is not limited thereto, and may be designed so that the payment process is completed, only on the management screen 110.

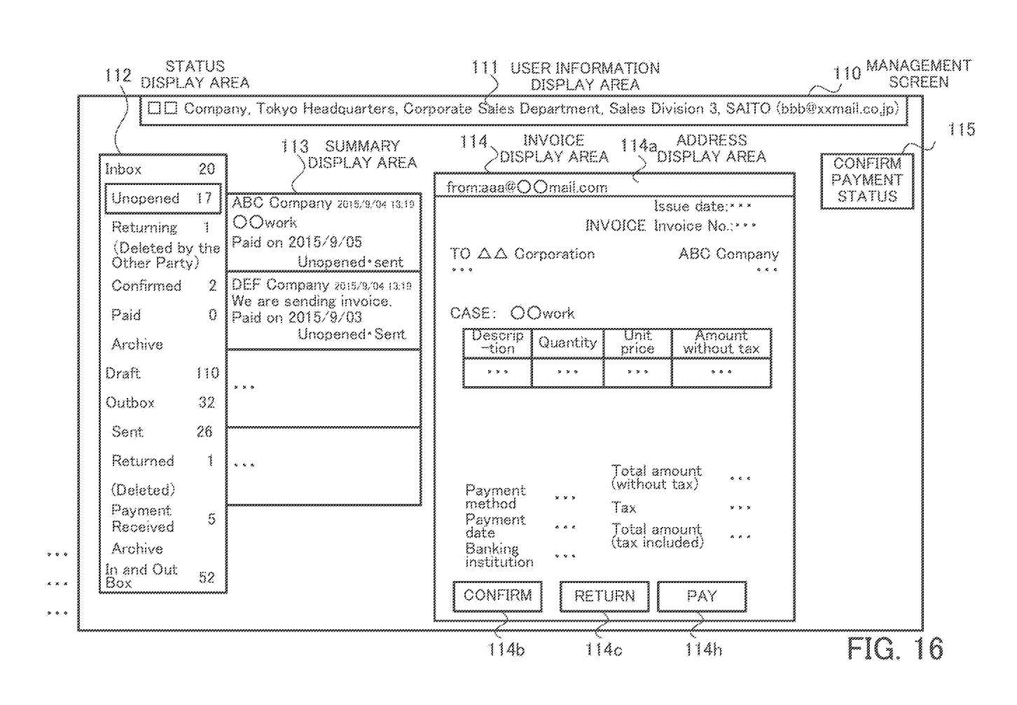

FIG. 16 is a view for explaining a second application example.

Specifically, in the case where invoice data placed in the InBox folder is selected, a Pay button 114h is displayed in the invoice display area 114. When the accounting personnel of the bill-to party designates a payment destination and selects the Pay button 114h, the amount indicated in the invoice data is transferred from a previously designated account of the bill-to party to the payment destination account designated by the accounting personnel of the bill-to party. After that, the same processing as the first application example is performed.

As a result, it is possible to further automate the money transfer process.

In this connection, in the present embodiment, transactions are made via a bank. Alternatively, the embodiment is applicate to the case where transactions are made, not via any bank.

In addition, processes performed by the invoice management apparatus 1 may be performed by a plurality of apparatuses in a distributed manner.

In addition, in the embodiment, the invoice management apparatus 1 has various storage units including the invoice data storage unit 12. Alternatively, each storage unit may be provided at a different location from the data processing unit 11 in cloud-based platform.

Furthermore, invoices include invoices for virtual money, such as bit coin, invoices relating to credit information, and others. Invoices themselves may be treated as virtual money.

Heretofore, the information processing apparatus and information processing method of the present invention have been described as the embodiment illustrated. The invention is not limited thereto, and the components of each unit may be replaced with other components having equivalent functions or other components. In addition, other desired configurations and steps may be added to the invention.

Further, two or more desired configurations (features) in the above-described embodiment may be combined.

The above-described processing functions may be implemented by using a computer. In this case, a program is prepared, which describes processes for the functions of the invoice management apparatus 1. A computer implements the above-described processing functions by executing the program. The program describing the intended processes may be recorded on a computer-readable recording medium. Computer-readable recording media include magnetic storage devices, optical discs, magneto-optical recording media, semiconductor memories, etc. The magnetic storage devices include HDDs, Flexible Disks (FD), Magnetic Tapes, etc. The optical discs include DVDs, DVD-RAMs, CD-ROMs, CD-RWs, etc. The magneto-optical recording media include MOs (Magneto-Optical disk), etc.

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer over a network, the computer may sequentially run this program.

In addition, the above-described processing functions may also be implemented wholly or partly by using DSP (digital signal processor), ASIC (application-specific integrated circuit), PLD (programmable logic device), or other electronic circuits.

According to one aspect, it is possible to get information in advance about a payment destination account for each invoice.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus, comprising:
a memory configured to store therein aggregation target data in which at least one payment destination is previously set; and
a processor configured to perform a process including
obtaining a designated payment destination for each of the aggregation target data, and
adding up invoice amounts indicated in the aggregation target data, for each payment destination,
wherein each of the aggregation target data is given a status indicating whether a payment destination has been designated or not, and
wherein the process further includes adding up invoice amounts indicated in the aggregation target data given a status indicating that no payment destination has been designated.

2. An information processing apparatus, comprising:
a memory configured to store therein aggregation target data in which at least one payment destination is previously set; and
a processor configured to perform a process including
obtaining a designated payment destination for each of the aggregation target data, and
adding up invoice amounts indicated in the aggregation target data for each payment destination,
wherein the process further includes adding up invoice amounts for a payment destination other than payment destinations previously set in the aggregation target data.

3. An information processing method, comprising:
referring, by a computer, to a memory storing therein aggregation target data in which at least one payment destination is previously set, and obtaining a designated payment destination for each of the aggregation target data; and
adding up, by the computer, invoice amounts indicated in the aggregation target data for each payment destination,
wherein the adding up includes adding up invoice amounts indicated in the aggregation target data given a status indicating that no payment destination has been designated, the aggregation target data each being given a status indicating whether a payment destination has been designated or not.

4. A non-transitory computer-readable storage medium storing a computer program that causes a computer to perform a process comprising:
referring to a memory storing therein aggregation target data in which at least one payment destination is previously set, and obtaining a designated payment destination for each of the aggregation target data; and
adding up invoice amounts indicated in the aggregation target data for each payment destination,
wherein the adding up includes adding up invoice amounts indicated in the aggregation target data given a status indicating that no payment destination has been designated, the aggregation target data each being given a status indicating whether a payment destination has been designated or not.
